(19) United States
(12) Patent Application Publication
(10) Pub. No.: US 2008/0191520 A1
(43) Pub. Date: Aug. 14, 2008

(54) Air Supply Device for a Motor Vehicle Seat and Method for the Operation Thereof

(75) Inventors: Dietmar Hartmann, Deckenpfronn (DE); Karl Pfahler, Stuttgart (DE); Lothar Renner, Nufringen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, Stuttgart (DE)

(21) Appl. No.: 11/630,267

(22) PCT Filed: Jun. 17, 2005
(86) PCT No.: PCT/EP2005/006546

§ 371 Date: Nov. 7, 2007

(30) Foreign Application Priority Data
Jun. 25, 2004 (DE) 10 2004 030 706.7

(51) Int. Cl. A47C 31/00; F24H 3/02; B60H 1/22

(52) U.S. Cl. 297/180.12; 454/120; 297/217.1; 165/202

(57) ABSTRACT

An air supply mechanism for a vehicle seat has an air discharging opening which is provided in the upper region of the vehicle seat and via which the head, shoulder, and neck region of a seat occupant can be subjected to an airflow in order to reduce undesirable draft phenomena. The airflow can be regulated with a control device, by regulating a blower speed of a fan, and can be heated via a heating element. The heating element has three heating stages which can be selected by a manually setting a regulating device by the seat occupant in order to select a heating stage and/or by the control device in response to an external parameter value. It is possible for the control device to regulate the blower speed of the fan in response to a further external parameter value. This construction makes it possible for the sensation of heat experienced by the seat occupant to be taken into account in the elimination of a sensation of a draft.

The invention relates to an air supply mechanism for a vehicle seat according to the precharacterizing clause of patent claim 1, and to a method for the operation thereof.

DE 102 26 008 A1 discloses an air supply mechanism for a vehicle seat of an open vehicle with at least one air discharging opening which is provided in the upper region of the vehicle seat and via which the head, shoulder and neck region of the seat occupant can be subjected to an airflow in order to reduce undesirable draft phenomena. In this case, the airflow can be regulated by means of a control device and, when the air supply mechanism is switched on, is set as a function of an automatically detected external parameter value, for example, an external temperature, and/or a specified value which can be selected by the seat occupant, to an assigned basic value from which a further setting of the airflow takes place as a function of an automatically detected further parameter value, for example, the driving speed. The two parameter values serve to set a low, average or a high basic value of the airflow with increasing driving speed, on the basis of the basic value set, the blower speed of the fan and a heating power of the heating element are increased, and vice versa.

DE 198 50 827 A1 discloses a vehicle ventilation device for directing air to the head and neck region of at least one occupant, essentially in a direction opposed to the direction of travel, with an air feeding device opening in the passenger compartment, an air deflecting device, an air dispensing device, an air acceleration device, in particular a fan, and an air heating device.

In this case, the air heating device and/or the air acceleration device can be controlled as a function of the vehicle speed.

However, in the case of this conventional air supply mechanism for a vehicle seat and in the case of this conventional vehicle ventilation device, attention is focused on the airflow which is regulated in predetermined stages as a function, inter alia, of speed and external temperature. The aim is to eliminate the sensation of a draft experienced by the seat occupant. In this case, however, the sensation of heat experienced by the seat occupant is not taken into consideration or not taken into consideration sufficiently, and, in particular, in the case of the conventional air supply mechanism for a vehicle seat, coordination with the surroundings takes place only to an inadequate extent; increasing the heating power of the heating element takes place merely in order, at a higher blower speed, i.e. a higher through flow of air, to obtain, as far as possible, a constant temperature of the airflow.

It is therefore the object of the present invention to develop an air supply mechanism for a vehicle seat and a method for the operation thereof in such a manner that the sensation of heat experienced by the seat occupant is sufficiently taken into account and therefore the heating comfort for the seat occupant increases significantly and, in particular, can also be adapted in accordance with the season, and, as a result, a more efficient and energy-saving operation of the air supply mechanism for a vehicle seat is also possible.

According to the invention, this object is achieved by an air supply mechanism for a vehicle seat with the features of claim 1 and by a method for the operation thereof with the features of claim 7. Advantageous developments of the invention are provided in the subclaims.

By means of the formation of three fixed heating stages of the heating element which are each assigned the same speed-dependent blower speed characteristic, the feeling of heat experienced by the occupant is readily taken into account, so that the heating comfort is increased for the seat occupant in a meaningful manner.

In an advantageous development of the invention, these three fixed heating stages can be changed in their entirety as a function of the weather and/or season to the effect that the heating power of all three heating stages is correspondingly raised (in cool weather, for example in March and November) or lowered (in the summer months) in accordance with an input signal from an external temperature sensor. The heating comfort for the seat occupant is therefore further increased.

These and further objects, features and advantages of the present invention become obvious below with reference to a preferred exemplary embodiment in conjunction with the drawing, in which:

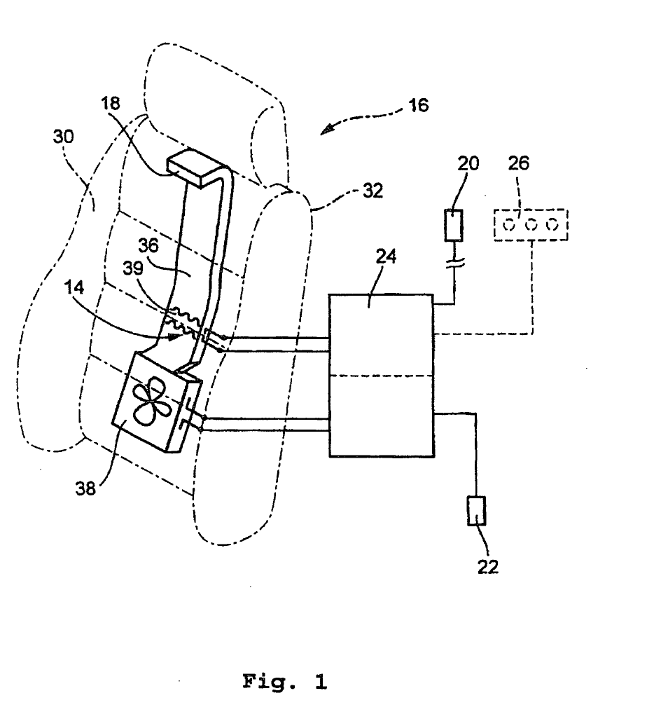

FIG. 1 shows a diagrammatic perspective view of parts of a backrest of a vehicle seat in which an air supply mechanism according to the invention is integrated,

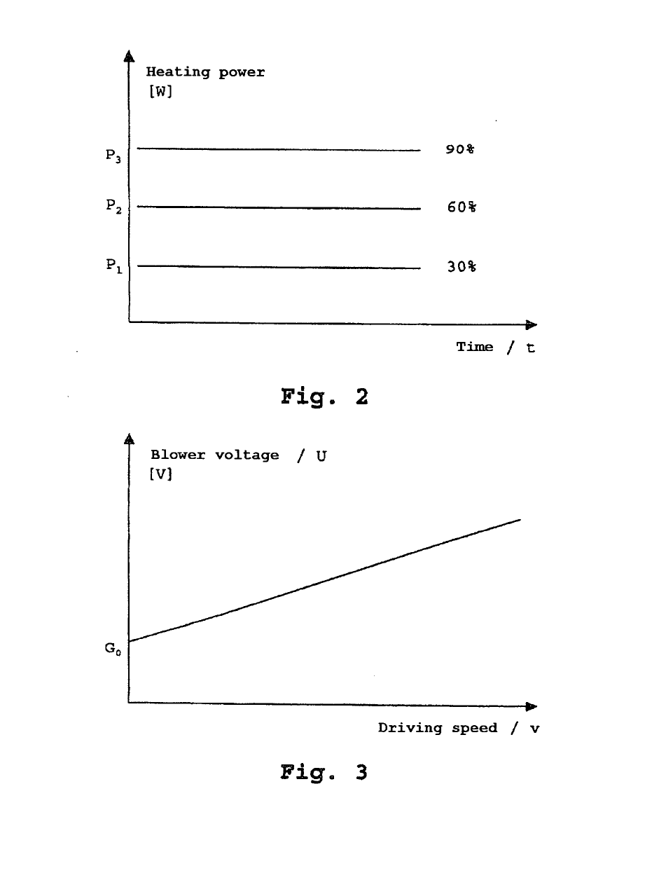

FIG. 2 shows an exemplary illustration of the profile over time of a heating power of a three-stage heating element,

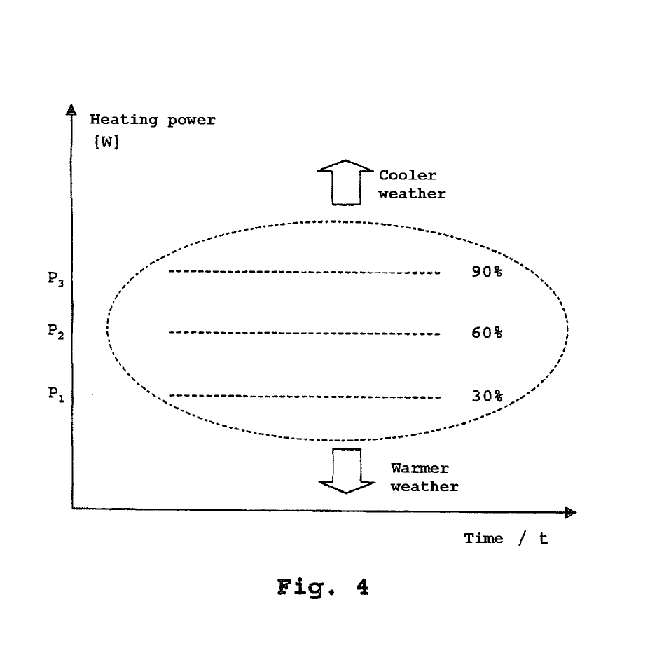

FIG. 3 shows the profile of a blower voltage as a function of the driving speed,

FIG. 4 shows an illustration of a shift of the three heating power levels as a function of a determined atmospheric situation, which is recognized, for example, via an external temperature sensor, and

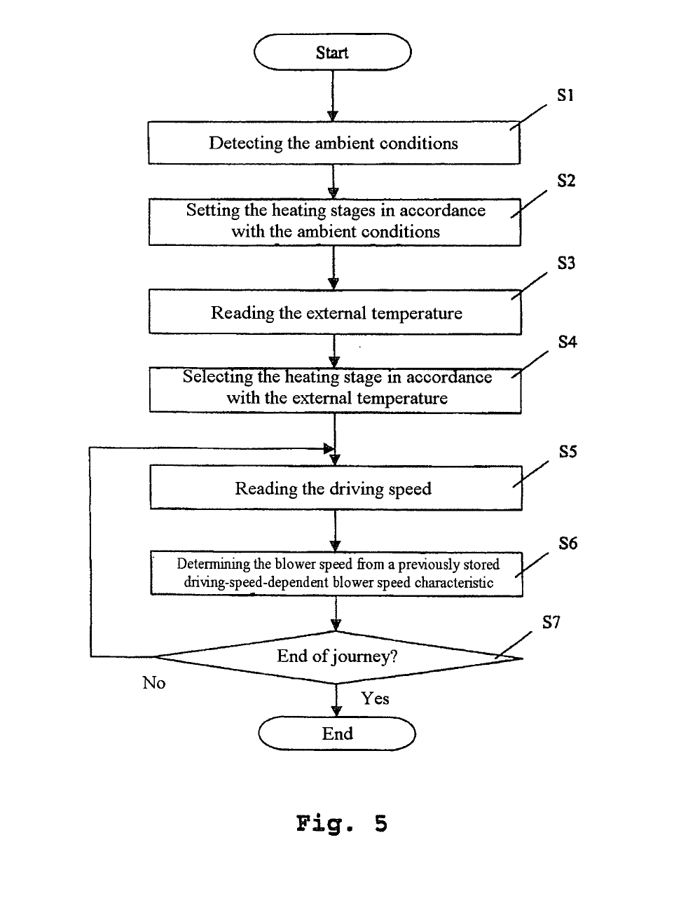

FIG. 5 shows a flow diagram of the method according to the invention for the operation of an air supply mechanism according to FIG. 1.

The air supply mechanism for a vehicle seat and the method according to the invention for the operation of the same will now be described in more detail below with reference to a preferred embodiment.

FIG. 1 illustrates, in a diagrammatic perspective view, parts of a backrest 16 of a vehicle seat 12 in which an air supply mechanism 14 is integrated. Of the backrest 16 of the vehicle seat 12, a backrest frame 30 and a rear lining 32 can be seen. A duct arrangement 36 of the air supply mechanism 14 is arranged within the backrest 16. Connected upstream of the duct arrangement 36 is a fan 38 which is held by a housing and the air intake of which takes place on the rear side of the backrest 16. In addition, a heating element 39 which is connected downstream of the fan 38 can be controlled via a control device 24 and with which the temperature of the airflow of the air supply mechanism 14 can be controlled is arranged within the duct arrangement 36. In the region of the head restraint (not shown in FIG. 1), the duct arrangement 36 opens into an air discharging opening 18 through which the temperature-controlled airflow emerges in the direction of the head, shoulder and neck region of the seat occupant in order to considerably reduce the draft phenomena occurring, for example, when driving with the folding top open. The air discharging opening 18 ends in a manner integrated approximately flush with the front side of the head restraint.

The air supply mechanism 14 can be connected both to a sensor 20 for detecting the external temperature and to a sensor 22 for detecting the driving speed. The two sensors 20, 22 are connected to the control device 24 which is arranged, for example, within the vehicle seat 12 and via which the airflow emerging from the air discharging opening 18 is regulated in the manner described below. In addition, a regulating device 26 is provided in the interior of the motor vehicle and is connected to the control device 24 and via which the seat occupant can undertake a setting of the airflow as described below. In the exemplary embodiment shown here, the driving speed is detected by an ABS control unit which is present in any case, converts the driving speed at a particular moment into an electronic signal and transmits it to the control device 24. The external temperature can be detected by a temperature sensor 20 which is present in any case for indicating the temperature in the cockpit, the temperature being converted into an electronic signal and being transmitted to the control device 24 in the vehicle seat 12.

In contrast to the prior art, in which a basic value for the fan characteristic is selected as a function of a detected external temperature and/or a setting of the regulation device 26 and the heating power is correspondingly increased when there is an increase in the blower speed and, as a result, the airflow is only regulated at a constant temperature of the blow-out air, in the case of the air supply mechanism according to the invention for a vehicle seat and the method according to the invention for the operation thereof, special attention is focused on regulating the ventilation temperature.

For this purpose, the heating element 39 is designed in such a manner that three different heating stages P1 to P3, for example low, medium and high, i.e. 30%, 60% and 90%, are present and can be set, as shown in FIG. 2. A speed-dependent blower speed characteristic is stored, as shown in FIG. 3, in a memory device (not shown) which is integrated, for example, in the control device 24, this blower speed characteristic being identically assigned to each of the heating stages. In the case of the air supply mechanism according to the invention, just one speed-dependent blower speed characteristic is still required and stored.

The control device 24 receives a signal, according to which one of the three heating stages P1 to P3 of the heating element 39 is selected, either from the regulating device 26, at which the seat occupant selects one of the heating stages P1 to P3, or from the sensor 20 which detects the external temperature. The blower speed is then regulated in accordance with the detected driving speed, starting from a working point G₀, by the control device 24 in response to a starting signal from the sensor 22, which detects the driving speed, with reference to the speed-dependent blower speed characteristic stored in the memory device.

The blower speed and therefore the blow-out airflow thereby increase as the driving speed increases while the temperature of the blow-out air is set taking a manual setting by the seat occupant and/or the detected external temperature into account. As a result, in contrast to the conventional air supply mechanism for a vehicle seat, in which only a speed-dependent adaptation of the blow-out airflow takes place, the temperature of which has a predetermined value, the temperature of the blow-out air is now selected taking the settings by the seat occupant and/or the external temperature into account and, in addition, the intensity of the blow-out airflow is regulated as a function of speed, i.e. it increases as the vehicle speed increases. The air-conditioning comfort for the seat occupant is therefore improved in a meaningful manner, since there is no sensation of draft due to the temperature of the blow-out air being too low at the current external temperature.

In a preferred development of the invention, the control device 24 additionally has a memory device (not shown) for external temperature values, to which the external temperature values detected by the sensor 20 are supplied, and an analyzing device. The analyzing device analyzes the profile of the stored external temperature values over time and determines from them whether cool weather is present, as may occur, for example, in March and November, or warm weather, as may occur, for example, in August, and outputs this determination result to the control device 24. In response to this determination result, if cool weather is identified, the control device 24 causes uniform raising of the heating power of all three heating stages P1 to P3 and, if warm weather is identified, causes uniform lowering of the heating power of all three heating stages P1 to P3, as illustrated in FIG. 4.

It is thereby ensured that, even at more extreme ambient conditions, such as, for example, constantly lower or higher external temperatures, there is an even better reaction to these ambient conditions, i.e. adaptation of the temperature of the blow-out air, so that heating comfort corresponding to the season is possible without requiring a multiplicity of heating stages of the heating element 39. In addition, by lowering the heating stages P1 to P3, for example in midsummer, and raising the heating stages P1 to P3, for example in spring and autumn, energy can be saved and the adaptability of the temperature of the blow-out air to the external temperature improved. Of course, it is also conceivable to detect the presence of various seasons and/or more extreme ambient conditions over a longer period of time with reference to different signals than from external temperature values, such as, for example, via time signals or the like.

The method according to the invention for the operation of an air supply mechanism for a vehicle seat, which is constructed as described above with reference to FIG. 1, is explained in more detail below with reference to FIG. 5.

The method according to the invention begins with a starting of the engine. First of all, in a step S1, ambient conditions, such as, for example, an external temperature, are optionally detected as the external parameter value. Then, in a step S2, in accordance with the ambient conditions detected in step S1, the heating stages P1 to P3, on the basis of values stored in a memory device, are optionally either used as stored or, if cool weather is identified, are optionally shifted upward by a predetermined value or, if warm weather is identified, are shifted downward by a predetermined value. As an alternative to step S1 and S2, a setting of the regulating device 26 by the seat occupant, via which regulating device one of the heating stages is selected manually, can be detected. Subsequently, in a step S3, reading of the detected external temperature and/or the detected setting of the regulating device 26 takes place and, in step S4, selecting of one of the three heating stages of the heating element 39 in accordance with the read detected external temperature and/or the detected setting of the regulating device 26 takes place. Subsequently, in step S5, the driving speed v is detected as a further external parameter value and read and, in step S6, the blower speed of the fan 38 is determined from a driving-speed-dependent blower speed characteristic stored in a memory device. If it is identified in step S7 that the journey has not yet ended, then a return is made to step S5 and a driving-speed-dependent regulation of the blower speed is carried out. Otherwise, the method is ended.

In this manner, it is possible with the method according to the invention to carry out a driving-speed-dependent regulation of the blow-out airflow by means of which a sensation of draft experienced by the seat occupant is avoided, with, in addition, the thermal sensation of comfort experienced by the seat occupant being significantly improved by the regulation of the temperature of the blow-out air.

1-10. (canceled)

11. An air supply mechanism for a vehicle seat, with an air discharging opening which is provided in an upper region of the vehicle seat and via which a head, shoulder, and neck region of a seat occupant can be subjected to an airflow in order to reduce undesirable draft phenomena, comprising:
a fan,
a heating element, and
a control device, which regulates an airflow of the fan by regulating a blower speed of the fan,
wherein the air flow is heatable via the heating element,
wherein the heating element has three heating stages which can be selected by the control device in response to a first external parameter value, and
wherein it is possible for the control device to regulate the blower speed of the fan in response to a second external parameter value.

12. The air supply mechanism as claimed in claim 11, wherein the first external parameter value is an external temperature.

13. The air supply mechanism as claimed in claim 11, wherein the first external parameter valve or the second external parameter value is a driving speed.

14. The air supply mechanism as claimed in claim 11, further comprising an analyzing device that is constructed to analyze first external parameter values stored in a memory device, wherein the analyzing device can output an analytical result to the control device, and wherein, in response to the analytical result, the control device can cause shifting of all three heating stages of the heating element.

15. The air supply mechanism as claimed in claim 12, further comprising an analyzing device that is constructed to analyze first external parameter values stored in a memory device, wherein the analyzing device can output an analytical result to the control device, and wherein, in response to the analytical result, the control device can cause shifting of all three heating stages of the heating element.

16. The air supply mechanism as claimed in claim 14, wherein the analyzing device carries out an analysis in order to identify which season is present, and wherein the control device can cause, in relation to a starting situation, an increase in all three heating stages in spring and autumn and a decrease in all three heating stages in midsummer.

17. The air supply mechanism as claimed in claim 15, wherein the analyzing device carries out an analysis in order to identify which season is present, and wherein the control device can cause, in relation to a starting situation, an increase in all three heating stages in spring and autumn and a decrease in all three heating stages in midsummer.

18. An air supply mechanism for a vehicle seat, with an air discharging opening which is provided in an upper region of the vehicle seat and via which a head, shoulder, and neck region of a seat occupant can be subjected to an airflow in order to reduce undesirable draft phenomena, comprising:
a fan,
a heating element, and
a control device, which regulates an airflow of the fan by regulating a blower speed of the fan,
wherein the airflow is heatable via the heating element,
wherein the heating element has three heating stages which can be selected manually by the seat occupant, and
wherein it is possible for the control device to regulate the blower speed of the fan in response to an external parameter value.

19. The air supply mechanism as claimed in claim 18, wherein the first external parameter valve or the second external parameter value is a driving speed.

20. The air supply mechanism as claimed in claim 18, further comprising an analyzing device that is constructed to analyze first external parameter values stored in a memory device, wherein the analyzing device can output an analytical result to the control device, and wherein, in response to the analytical result, the control device can cause shifting of all three heating stages of the heating element.

21. The air supply mechanism as claimed in claim 20, wherein the analyzing device carries out an analysis in order to identify which season is present, and wherein the control device can cause, in relation to a starting situation, an increase in all three heating stages in spring and autumn and a decrease in all three heating stages in midsummer.

22. A method for operating an air supply mechanism for a vehicle seat, with an air discharging opening provided in an upper region of the vehicle seat and via which the head, shoulder, and neck region of a seat occupant can be subjected to an airflow in order to reduce undesirable draft phenomena, the airflow being regulatable with a control device by regulating a blower speed of a fan and heatable via a heating element, comprising:
detecting, in a first step, ambient conditions,
setting, in a second step, heating stages of a three-stage heating element in accordance with the ambient conditions detected,
reading an external temperature, setting a regulating device for the manual selection of a heating stage by the seat occupant, or both reading the external temperature and setting the regulating device in a third step,
selecting, in a fourth step, one of the heating stages of the three-stage heating element in accordance with at least one of the external temperature and a setting of the regulating device,
reading, in a fifth step, a driving speed,
determining, in a sixth step, the blower speed from a previously stored blower speed characteristic in accordance with the driving speed, and
repeating the fifth and sixth steps until an end of a journey is recognized.

23. The method as claimed in claim 22, wherein the ambient conditions include an external temperature.

24. The method as claimed in claim 22, wherein three previously stored heating stages for the heating element are used within a predetermined temperature interval of the external temperature, wherein, when the temperature exceeds the highest value of the temperature interval, the previously stored heating stages are raised by a predetermined value, and wherein, when the temperature falls below the lowest value of the temperature interval, the previously stored heating stages are lowered by a predetermined value.

25. A method for operating an air supply mechanism for a vehicle seat, with an air discharging opening provided in an upper region of the vehicle seat and via which the head, shoulder, and neck region of a seat occupant can be subjected to an airflow in order to reduce undesirable draft phenomena, the airflow being regulatable with a control device by regulating a blower speed of a fan and heatable via a heating element, comprising:
reading an external temperature, setting a regulating device for the manual selection of a heating stage by the seat occupant, or both reading the external temperature and setting the regulating device in a first step,
selecting, in a second step, one of the three heating stages of the three-stage heating element in accordance with at least one of the external temperature and a setting of the regulating device,
reading, in a third step, a driving speed,
determining, in a fourth step, the blower speed from a previously stored blower speed characteristic in accordance with the driving speed, and
repeating the third and fourth steps until an end of the journey is recognized.
